(19) United States
(12) Patent Application Publication
(10) Pub. No.: US 2021/0331279 A1
(43) Pub. Date: Oct. 28, 2021

(54) DEVICE FOR POSITIONING AT LEAST ONE SHAFT

(71) Applicants: Mahle International GmbH, Stuttgart (DE); Maschinenbau-Service-Automatisierungstechnik Chemnitz GmbH, Chemnitz (DE)

(72) Inventors: Arthur Mello, Fellbach (DE); Antonio Menonna, Ditzingen (DE); Stefan Morgenstern, Munich (DE)

(21) Appl. No.: 17/240,958

(22) Filed: Apr. 26, 2021

(30) Foreign Application Priority Data
Apr. 27, 2020 (DE) 102020205267.0

(51) Int. Cl. B23P 11/02; F16D 1/08; F16H 53/02

(52) U.S. Cl. CPC B23P 11/025; F16D 2300/12; F16H 53/025; F16D 1/0858

(57) ABSTRACT

A device for positioning a shaft relative to a functional element including at least one hub for the shaft. The device may include a tailstock for axially aligning the shaft with respect to the at least one hub of the functional element. The tailstock may include a radially adjustable centring cone for the shaft. The tailstock may have an outer diameter that is smaller than an inner diameter of the at least one hub.

### CROSS-REFERENCE TO RELATED APPLICATIONS

This application claims priority to German Patent Application No. DE 10 2020 205 267.0, filed on Apr. 27, 2020, the contents of which is hereby incorporated by reference in its entirety.

### TECHNICAL FIELD

The present invention relates to a device for positioning a shaft relative to at least one functional element comprising a hub for the shaft. In addition, the invention relates to a method for the thermal joining of a shaft to at least one functional element comprising a hub for the shaft using such a device.

### BACKGROUND

From DE 10 2008 064 194 A1 a device for positioning at least one functional element comprising a recess for a shaft in a predetermined angular position on the shaft is known, wherein the device comprises a mount intended for a functional element.

From DE 10 2007 056 638 A1 a further device for mounting a composite, consisting of at least one shaft carrying functional elements and a housing supporting these in undivided bearings, wherein the housing comprises positioning devices which, prior to the joining, hold the functional elements in a predefined phase position in the housing so that the at least one shaft can be slid through the bearings of the housing and openings in the functional elements. Here, the positioning device is provided with recesses for the functional elements which have a stop which supports the functional element against the joining direction of the shaft, wherein the recess of the positioning devices have a part contour of the contour of the functional elements as negative profile, so that the functional elements can be held in a phase position according to their joining position later on. By way of this, a particularly phase-accurate positioning is to be achieved.

From DE 10 2009 060 350 A1 a device for mounting a shaft carrying functional elements is known, wherein the device comprises a machine platform, on which a plurality of positioning shims for the aligned, correct positioning of the functional elements is arranged in such a manner that a shaft can be slid in. The positioning shims are reversibly fixed on a frame which in turn is reversibly fixed on the machine platform. Here, a rapid change of a production process is to be made possible by having multiple frames available.

From DE 10 2011 106 981 A1 a device for producing a joined connection of at least one joining part comprising a bore with a shaft is known, wherein the device has a joining device with a first gripper for gripping the shaft and a second gripper for the position-oriented gripping of the joining part. Here, the shaft, at one end, is centrically clamped in a clamping means that is mounted in a rotationally drivable manner and is centred at the other end with a centring point, wherein the joining part is heated to a desired temperature and the bore expands to an oversize relative to the shaft diameter. By way of this, a device is to be created in particular with which a joining process can be optimised.

From EP 2 777 868 B1 a further device for positioning at least one functional element comprising a hub for a shaft on the shaft is known.

Disadvantageous with the known devices however is an elaborate coaxial aligning between shaft and hub of a functional element to be joined on the shaft, wherein upon an imprecise coaxiality score marks can develop which damage a surface of the shaft.

### SUMMARY

The present invention therefore deals with the problem of stating a device by means of which a shaft can be comparatively easily aligned coaxially to a hub of a functional element to be joined thereon and the disadvantages known from the prior art can thereby be avoided.

According to the invention, this problem is solved through the subject matter of the independent claim(s). Advantageous embodiments form the subject matter of the dependent claim(s).

With a device for joining functional elements comprising a hub on an associated shaft, the present invention is based on the general idea of not aligning the functional elements but the shaft, this in a technically extremely simple manner using a centring cone on a tailstock that is mounted so as to be radially movable. The device for positioning a shaft relative to at least one functional element comprising a hub for the shaft used for this purpose according to the invention, in particular a cam, comprises a tailstock for the coaxial alignment of the shaft with respect to the hub of the at least one functional element, wherein on the longitudinal end side of this tailstock a radially adjustable centring cone for the shaft is provided. In addition, the tailstock has an outer diameter that is smaller than the inner diameter of the hub, so that the tailstock including cone can be moved with play through the hub of the functional element to be joined. When the tailstock with its centring cone now engages in the hollow shaft and feeds the same together with the guide carriage towards the hub, it is possible for the shaft to yield in the radial direction easily and without problems provided that the shaft does not run coaxially to the associated hub of the functional element to be joined thereon. Up to now, a non-coaxial arrangement of the shaft and the hub of the functional element resulted in that the axis of the hub and of the shaft ran parallel to one another and because of this the shaft was eccentrically slid into the hub, as a result of which undesirable score marks developed on the surface of the shaft. Although such score marks in the region of the hub are generally harmless or even advantageous for an increased torque transmission, these do not however run merely under the hub or in the region of the hub, but over the entire axial joining section of the functional element on the shaft, so that such score marks also occur on the surface regions of the shaft on which these have to be subsequently elaborately removed again, in particular when these are bearing regions for example. With the device according to the invention it is possible for the first time during the joining of the shaft in the hubs of the functional elements to comparatively easily achieve a radial yielding of the shaft and thus the establishment of a coaxiality.

In an advantageous further development of the solution according to the invention, the centring cone is mounted via an air cushion or a ball bearing in the radial direction relative to the tailstock. Such an air cushion represents a particularly smooth-running mounting, just like a ball bearing. Such a ball bearing can for example comprise balls in a face-end space of the tailstock, wherein an axial height of this space is slightly smaller than a diameter of the balls, so that the centring cone with its surface facing the space is mounted on the balls. By means of such an air cushion mounting or ball bearing, a rotating of the shaft can also be additionally made possible.

In a further advantageous embodiment of the solution according to the invention, the centring cone has a central axial extension, via which it engages with clearance fit in an axial recess in the tailstock. By way of such an axial extension the centring cone is thus mounted on the tailstock wherein because of the clearance fit of the axial extension in the recess a predefined radial clearance is provided, via which a coaxiality that may not be present under certain conditions can be offset between the shaft and the hub.

Practically, an annular groove that is open towards the outside is arranged on the axial extension. By way of such an annular groove it is possible to bring about an axial fixing of the centring cone on the tailstock, for example by way of an engagement pin or grub screws. For example, at least three radially extending internal threads for receiving a grub screw each can be provided in the tailstock, wherein these grub screws in the installed state engage in the annular groove on the axial extension side and by way of this bring about a rotatable axial fixing of the centring cone on the tailstock. By loosening the grub screws, the centring cone can be comparatively easily removed from the tailstock, for example for maintaining the ball bearing.

In a further advantageous embodiment of the solution according to the invention, a spring and a ball are provided in the screw-in direction in front of each grub screw, wherein the balls in the installed state engage in the annular groove on the axial extension side and centre the centring cone. By means of such spring pre-loaded balls, which engage in the annular groove on the axial extension side, a pre-centring of the axial extension in the recess on the tailstock side and thus a pre-centring of the centring cone relative to the tailstock in the radial direction is possible. When, alternatively, for example grub screws are exclusively used care has to be taken with these that the same are not completely screwed into the annular groove and thereby obstruct a radial clearance of the axial extension or of the centring cone, but merely so far until an axial securing of the centring cone of the tailstock is provided.

Furthermore, the present invention is based on the general idea of stating a method for the thermal joining of a shaft to at least one functional element comprising a hub using the device described in the preceding paragraphs. With the method according to the invention, the shaft is initially cooled or alternatively the functional element heated. Obviously it is also conceivable that both the shaft is cooled and also the functional element heated. Following this, the tailstock with its centring cone is moved through the hub of the functional element to be joined. The shaft is moved up against the centring cone of the tailstock for example by means of a guide carriage and subsequently pushed against the functional element. When, in the process, the axis of the shaft does not run coaxially to the axis of the hub of the functional element to be joined, the shaft meets the hub eccentrically and would, upon a further sliding to the hub result in score marks on the surface of the shaft. However, in the case of an existing parallelism of the axes of the shaft and of the hub of the functional element it is possible with the device according to the invention to adjust the shaft likewise in the radial direction so that the same, upon any existing eccentricity, is radially shifted and thereby the coaxiality established, as a result of which the shaft can be preferentially slid free of score marks into the hub or through the hub of the functional element to be joined on the shaft. Following this, a temperature equalisation fixing the functional element on the shaft is awaited, in order to thereupon be able to remove the shaft including the functional element fixed thereon from the device. With the method according to the invention it is thus possible during the joining operation to align the shaft in the radial direction to the hub of the functional element to be joined thereon and thereby establish a coaxiality as a result of which any undesirable formation of score marks that may have been occurring up to now under certain conditions because of a hub seizing-up on the surface of the shaft can be avoided.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

There it shows, in each case schematically,

FIG. 1 shows a device according to the invention for positioning a shaft relative to at least one functional element comprising a hub for the shaft,

FIG. 2 shows a sectional representation through a tailstock according to the invention,

FIG. 3 shows a representation as in FIG. 2, however with another embodiment.

### DETAILED DESCRIPTION

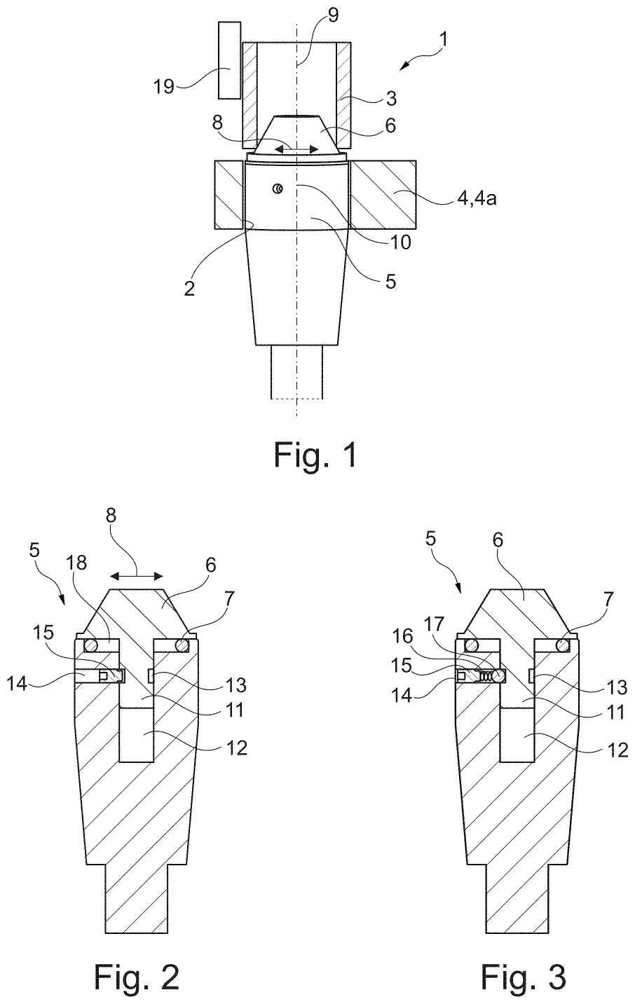

According to FIG. 1, a device 1 according to the invention for positioning a shaft 3 relative to at least one functional element 4 comprising a hub 2 for the shaft 3, for example a cam 4a, comprises a tailstock 5 for the coaxial alignment of the shaft 3 with respect to the hub 2 of the at least one functional element 4. Here, the tailstock 5 according to the invention comprises a radially adjustable centring cone 6 for the shaft 3 and additionally has an outer diameter that is smaller than the inner diameter of the hub 2.

Here, the centring cone 6 can be mounted in the radial direction 8 relative to the tailstock 6 by way of an air cushion or a ball bearing 7 (see FIGS. 2 and 3).

With the tailstock 6 according to the invention and the device 1 according to the invention it is possible for the first time, when joining the shaft 3 in the hub 2 of the functional element 4 to bring about a radial yielding of the shaft 3, provided an axis 9 of the shaft 3 does not run coaxially to the axis 10 of the hub 2, but parallel to the same. This helps in particular in reliably avoiding undesirable score marks on a surface of the shaft 3 which would be created if the shaft 3 with its axis 9 parallel to the axis 10 of the hub 2 were to be introduced or pressed into the same.

Viewing the FIGS. 2 and 3 it is noticeable that the centring cone 6 has a central axial extension 11 via which it engages with clearance fit, i.e. with radial clearance, in an axial recess 12 in the tailstock 5. On the axial extension 11, an annular groove 13 that is open towards the outside can be arranged, via which an axial fixing of the centring cone 6 in the tailstock 5 becomes possible. In the tailstock 5, at least three radially extending internal threads 14 can be provided, in which a grub screw 15 each for axially fixing the centring cone 6 on the tailstock 5 can be screwed. In the installed state, the grub screws 15 directly (see FIG. 2) or indirectly (see FIG. 3) engage in the annular groove 13 on the axial extension side.

In the embodiment shown according to FIG. 3 a spring 16 and a ball 17 are provided in the screwing-in direction in front of each grub screw 15, wherein the balls 17 in the installed state engage in the annular groove 13 on the axial extension 11 and thereby pre-centre the axial extension 11 and via the same also the centring cone 6.

The ball bearing 7 according to the FIGS. 2 and 3 is arranged in a face-end recess 18 of the tailstock 6, wherein a diameter of the individual balls of the ball bearing 7 is slightly larger than an axial extension of the recess 18, as a result of which a rotation or a radial clearance of the centring cone 6 relative to the tailstock 5 is made possible.

Here, joining the functional elements 4 on the shaft 3 takes place as follows:

Initially, the shaft 3 are/is cooled and/or the functional element 4 heated, as a result of which a thermal joining is possible in the first place. Alternatively, a joining exclusively by means of a press fit is obviously also possible. Following this, the tailstock 5 with its centring cone 6 is moved through the hub 2 of the functional element 4, for example of the cam 4a, wherein in turn the shaft 3 is subsequently moved up against the centring cone 6 of the tailstock 5 by means of a guide carriage 19 (see FIG. 1). Thus, the shaft 3 is pushed up against the functional element 4, wherein upon a parallelism of the axis 9 of the shaft 3 and of the axis 10 of the hub 2 when the shaft 3 meets the hub 2 or the functional element 4 a radial adjusting of the centring cone 6 and thus a radial adjusting of the shaft 3 takes place, so that the axis 9 and 10 subsequently run coaxially, i.e. are identical. Through the comparatively easy radial adjustability of the centring cone 6 it is thus possible that the shaft 3, upon a determined eccentricity, yields relative to the hub 2 as a result of which a formation of score marks through an eccentric pressing-on of the functional element 4 on the shaft 3 can be reliably avoided. After the shaft 3 has been slid into the hub 2 and pending a temperature equalisation the functional element 4 is fixed on the shaft 3. Following this, the shaft 3 can be removed from the device 1 together with the functional element 4 joined thereon.

With the method according to the invention and the device 1 according to the invention it is thus possible for the first time to make possible a radial yielding of the shaft 3 during the joining in a hub 2 of a functional element 4, as a result of which in particular score marks on the surface of the shaft 3 can be avoided, which would develop if the shaft 3 were to be eccentrically slid into the hub 2. By way of this, elaborate reworking can be avoided in particular.

1. A device for positioning a shaft relative to a functional element including at least one hub for the shaft, the device comprising:
a tailstock for axially aligning the shaft with respect to the at least one hub of the functional element;
the tailstock including a radially adjustable centring cone for the shaft; and
wherein the tailstock has an outer diameter that is smaller than an inner diameter of the at least one hub.

2. The device according to claim 1, wherein the centring cone is adjustably mounted on the tailstock via at least one of an air cushion and a ball bearing such that the centring cone is adjustable in a radial direction relative to the tailstock.

3. The device according to claim 1, wherein the centring cone includes a central axial extension, via which the centring cone engages, with a clearance fit, an axial recess disposed in the tailstock.

4. The device according to claim 3, wherein the centring cone further includes an annular groove disposed in the axial extension and that is open towards an outside.

5. The device according to claim 1, wherein the tailstock includes at least three radially extending internal threads structured and arranged to receive a grub screw.

6. The device according to claims 4, wherein:
a grub screw engages the annular groove and secures the centring cone to the tailstock in an axial direction; and
the tailstock includes at least three radially extending internal threads structured and arranged to receive the grub screw.

4. The device according to claims 4, wherein:
the tailstock includes at least three radially extending internal threads structured and arranged to receive a grub screw;
a spring and a ball are arranged in front of the grub screw in a screwing-in direction; and
the ball, in an installed state, engage the annular groove and centre the centring cone relative to the tailstock.

8. A method for thermally joining a shaft to at least one functional element having a hub for the shaft via a device, the method comprising:
at least one of cooling the shaft and heating the at least one functional element;
adjusting a centring cone of a tailstock of the device through the hub, the centring cone configured to adjust radially relative to the tailstock and to engage the shaft, the tailstock having an outer diameter that is smaller than an inner diameter of the hub;
moving the shaft into engagement with the centring cone of the tailstock via a guide carriage;
when the shaft is not coaxially aligned with the hub and is pushed against the at least one functional element, radially adjusting the shaft via radially adjusting the centring cone;
fixing the at least one functional element on the shaft via awaiting a temperature equalisation; and
removing the shaft and the at least one functional element fixed thereon from the device.

9. A device for positioning a shaft relative to a functional element, comprising:
a tailstock having an outer diameter that is smaller than an inner diameter of a hub of the functional element;
a centring cone configured to axially engage the shaft; and
wherein the centring cone is adjustably connected to the tailstock such that the centring cone is radially adjustable relative to the tailstock.

10. The device according to claim 9, further comprising an air cushion, wherein:
the tail stock includes a face-end recess; and
the air cushion is disposed at least partially within the face-end recess and engages a rear surface of the centring cone.

11. The device according to claim 9, further comprising a ball bearing, wherein:
the tail stock includes a face-end recess; and
the ball bearing is disposed at least partially within the face-end recess and engages a rear surface of the centring cone.

12. The device according to claim 11, wherein a diameter of at least one ball of the ball bearing is greater than an axial depth of the face-end recess such that at least a portion of the ball bearing projects axially out of the face-end recess and contacts the rear surface of the centring cone.

13. The device according to claim 9, further comprising at least one of a ball bearing and an air cushion, wherein:
the tail stock includes a face-end recess; and
the at least one of the ball bearing and the air cushion is disposed at least partially within the face-end recess and engages a rear surface of the centring cone.

14. The device according to claim 13, wherein:
the tailstock further includes an axial recess extending through an axial surface of the tailstock that at least partially defines the face-end recess; and
the centring cone includes an axial extension disposed within the axial recess of the tailstock with radial clearance.

15. The device according to claim 14, wherein:
the tailstock further includes a radial passage extending from an outer circumferential surface of the tailstock to an inner circumferential surface of the tailstock that at least partially defines the axial recess;
the centring cone further includes an annular groove disposed in the axial extension; and
the radial passage of the tailstock and the annular groove of the centring cone are aligned with one another.

16. The device according to claim 15, wherein:
the tailstock further includes a plurality of radially extending internal threads disposed within the radial passage; and
the tailstock further includes a grub screw disposed completely within the radial passage and engaging at least some of the plurality of internal threads.

17. The device according to claim 16, wherein the grub screw projects into and engages the annular groove of the axial extension axially securing the centring cone to the tailstock.

18. The device according to claim 15, wherein:
the tail stock further includes a ball disposed within the radial passage; and
the ball engages the annular groove of the axial extension axially securing the centring cone to the tailstock.

19. The device according to claim 18, wherein:
the tailstock further includes a spring disposed within the radial passage; and
the spring is configured to pre-centre the centring cone within the axial recess of the tailstock via pressing the ball into engagement with the annular groove.

20. The device according to claim 19, wherein:
the tailstock includes a grub screw disposed completely within the radial passage; and
the spring is disposed radially between the grub screw and the ball.
